(19) United States
(12) Patent Application Publication
(10) Pub. No.: US 2006/0101173 A1
(43) Pub. Date: May 11, 2006

(54) Pin sharing system

(76) Inventors: Yu-Lun Cheng, Hsinchu City (TW); Chung-hung Tsai, Jhubei City (TW)

Correspondence Address: HOFFMAN WARNICK & D'ALESSANDRO, LLC, 75 STATE STREET, 14TH FL, ALBANY, NY, 12207, US

(21) Appl. No.: 11/065,012

(22) Filed: Feb. 24, 2005

(30) Foreign Application Priority Data
Nov. 10, 2004 (TW) 093134356

(51) Int. Cl. G06F 3/06

(52) U.S. Cl. 710/58

(57) ABSTRACT

The present invention discloses a pin sharing system for sharing with a peripheral device one of a plurality of pins configured between an ATA device and an I/O device. The system includes a peripheral controller, an ATA controller, and an I/O controller. The peripheral controller is used for receiving a pin request signal for the peripheral device and for generating a priority signal by sorting a plurality of modules of the peripheral device according to a sorting rule. The ATA controller is used for receiving a signal, transmitted via the pins, from the ATA device and for detecting the status of the shared pin to generate an ATA status signal. According to the ATA status signal, the pin request signal, and the priority signal, the I/O controller controls an available time of the shared pin used by the peripheral device.

### BACKGROUND OF INVENTION

1. Field of the Invention

The present invention relates to a pin sharing system, and more particularly to a pin sharing system for sharing with a peripheral device one of a plurality of pins configured between an advanced technology attachment (ATA) device and an input/output (I/O) device.

2. Description of the Prior Art

With the advance and development of science and technology, the electronic product design tends to have a small size and simple in its usage. Accordingly, the integrated circuit packing for controlling the electronic product also tends to be compact. Especially since the integrated circuit design tends to be small in size but more functions are intended, the number of peripheral devices it may be connected also increases. However, due to the nature of the integrated circuit packing, the number of pins used for connecting with the peripheral devices is fixed. Therefore, when the number of peripheral devices gradually increases, it is a problem to be solved as to how the limited pins for signal transmission can be effectively utilized.

### SUMMARY OF THE INVENTION

The objective of the present invention is to provide a pin sharing system for sharing with a peripheral device one of a plurality of pins configured between an advanced technology attachment (ATA) device and an input/output (I/O) device, wherein the shared pin is a device data pin (DD pin).

Another objective of the present invention is to provide a pin sharing system for sharing with a peripheral device one of a plurality of pins configured between an ATA device and an I/O device, wherein the shared pin is a device address pin (DA pin).

Another objective of the present invention is to provide a pin sharing system for sharing with a plurality of peripheral devices one of a plurality of pins configured between an ATA device and an I/O device.

According to the present invention, the pin sharing system includes a peripheral controller, an ATA controller, and an I/O controller. The peripheral controller is used for receiving a pin request signal for the peripheral device and for generating a priority signal by sorting/prioritizing a plurality of modules of the peripheral device according to a sorting rule. The ATA controller is used for receiving a signal, transmitted via the pins, from the ATA device and for detecting the status of the shared pin to generate an ATA status signal. According to the ATA status signal, the pin request signal, and the priority signal, the I/O controller controls an available time of the shared pin used by the peripheral device.

The advantage and spirit of the invention may be understood by the following recitations together with the appended drawings.

### BRIEF DESCRIPTION OF THE APPENDED DRAWINGS

FIG. 1 is a functional block diagram illustrating a pin sharing system according to an embodiment of the present invention.

FIG. 2 is a functional block diagram illustrating a pin sharing system according to another embodiment of the present invention.

FIG. 3 is a functional block diagram illustrating a pin sharing system according to another embodiment of the present invention.

FIG. 4 is a functional block diagram illustrating the structure of the systems shown in FIGS. 1 through 3.

FIG. 5 is a flowchart illustrating the pin sharing method according to an embodiment of the present invention.

FIG. 6 is a timing diagram illustrating the register/PIO data-in transfer according to the pin sharing method of the present invention.

FIG. 7 is a timing diagram illustrating the register/PIO data-out transfer according to the pin sharing method of the present invention.

FIG. 8 is a timing diagram illustrating the multiword DMA data-out transfer according to the pin sharing method of an embodiment of the present invention.

FIG. 9 is another timing diagram illustrating the multiword DMA data-out transfer according to the pin sharing method of another embodiment of the present invention.

FIG. 10 is another timing diagram illustrating the ultra DMA data-out transfer according to the pin sharing method of an embodiment of the present invention.

FIG. 11 is another timing diagram illustrating the ultra DMA data-out transfer according to the pin sharing method of another embodiment of the present invention.

FIG. 12 is a flowchart illustrating the pin sharing method according to another embodiment of the present invention.

### DETAILED DESCRIPTION OF THE INVENTION

The present invention discloses a pin sharing system for sharing with a peripheral device one of a plurality of pins configured between an advanced technology attachment (ATA) device and an input/output (I/O) device.

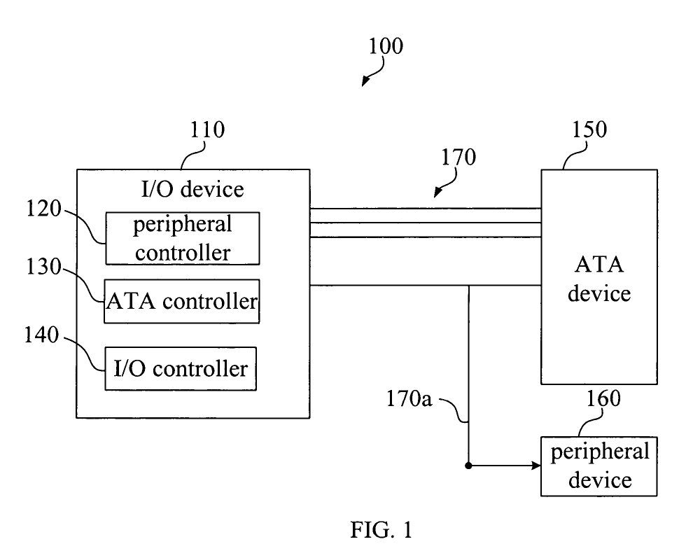

Referring to FIG. 1, FIG. 1 is a functional block diagram illustrating a pin sharing system 100 according to an embodiment of the present invention. The pin sharing system 100 includes an I/O device 110, a peripheral controller 120, an ATA controller 130, an I/O controller 140, an ATA device 150, and a peripheral device 160. The I/O device 110 connects with the ATA device 150 by a plurality of pins 170. The plurality of pins includes a pin 170a for transmitting data. The pin 170a is usually, but not limited to, a device data pin (DD pin). The pin 170a is further connected to the peripheral device 160, so the I/O device 110, the ATA device 150, and the peripheral device 160 share the pin 170a.

The peripheral controller 120 is used for receiving a pin request signal for the peripheral device 160 and for generating a priority signal by sorting a plurality of modules of the peripheral device 160 according to a sorting rule. The ATA controller 130 is used for receiving a signal, transmitted via the pins 170, from the ATA device 150 and for detecting the status of the shared pin 170a to generate an ATA status signal. According to the ATA status signal, the pin request signal, and the priority signal, the I/O controller 140 controls an available time of the shared pin 170a used by the peripheral device 160.

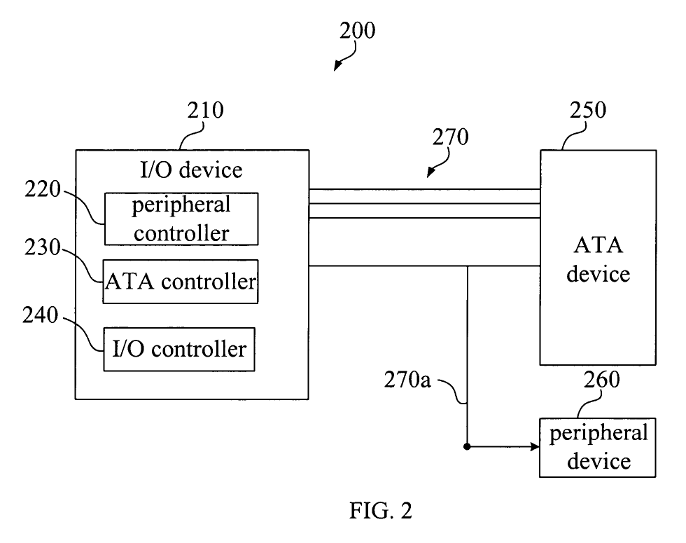

Referring to FIG. 2, FIG. 2 is a functional block diagram illustrating a pin sharing system 200 according to another embodiment of the present invention. The pin sharing system 200 includes an I/O device 210, a peripheral controller 220, an ATA controller 230, an I/O controller 240, an ATA device 250, and a peripheral device 260. The I/O device 210 connects with the ATA device 250 by a plurality of pins 270. The plurality of pins includes a pin 270a for transmitting address. The pin 270a is usually, but not limited to, a device address pin (DA pin). The pin 270a is further connected to the peripheral device 260, so that the I/O device 210, the ATA device 250, and the peripheral device 260 can share the pin 270a. The other elements and function of the pin sharing system 200 are substantially the same as the pin sharing system 100 shown in FIG. 1, and the redundant description is omitted.

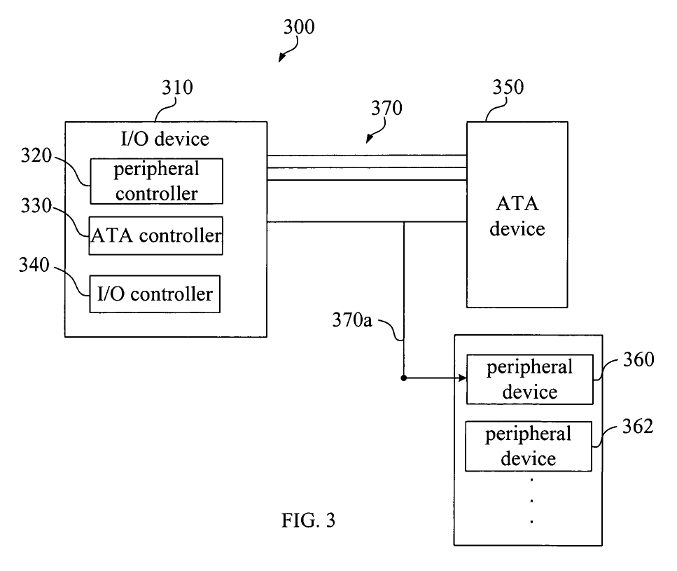

Referring to FIG. 3, FIG. 3 is a functional block diagram illustrating a pin sharing system 300 according to another embodiment of the present invention. The pin sharing system 300 includes an I/O device 310, a peripheral controller 320, an ATA controller 330, an I/O controller 340, an ATA device 350, and a plurality of peripheral devices 360. The I/O device 310 connects with the ATA device 350 by a plurality of pins 370. The plurality of pins includes a pin 370a shared with the plurality of peripheral devices 360. The peripheral controller 320 is used for simultaneously receiving a plurality of sub pin request signals for the peripheral devices 360 and for synthesizing the received sub pin request signals to generate a pin request signal. Afterward, the peripheral controller 320 sorts/prioritizes the peripheral devices 360 according to a sorting rule to generate a priority signal. The ATA controller 330 is used for receiving a signal, transmitted via the pins, from the ATA device 350 and for detecting the status of the shared pin 370a to generate an ATA status signal. According to the ATA status signal, the pin request signal, and the priority signal, the I/O controller 340 controls an available time of the shared pin 370a used by one of the peripheral devices 360.

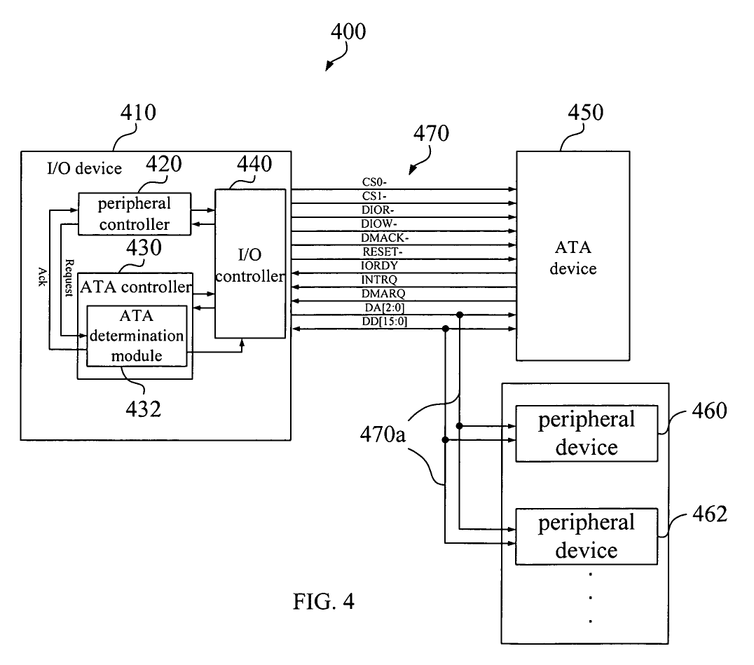

Referring to FIG. 4, FIG. 4 is a functional block diagram illustrating the structure of the systems shown in FIGS. 1 through 3. According to the present invention, the embodiments shown in FIGS. 1 through 3 can be described together with FIG. 4 and the similar elements shown in FIGS. 1 through 3 will be labeled with similar numerals. The pin sharing system 400 includes an I/O device 410, a peripheral controller 420, an ATA controller 430, an ATA determination module 432, an I/O controller 440, an ATA device 450, and a plurality of peripheral devices 460, 462, etc. The peripheral device may be a flash memory or the like. The I/O device 410 is connected to the ATA device 450 by a plurality of pins 470, wherein these pins 470 are defined in the standard ATA protocol including CS0, CS1, DIOR, DIOW, DMACK, RESET, IORDY, INTRQ, DMARQ, DA[2:0], DD[15:0], etc. The ATA protocol may be looked up in certain publications, and the detailed information and explanation is therefore omitted. According to the present invention, DA[2:0] and DD[15:0] are used to be the pin 470a shared by the ATA device 450 and the peripheral devices 460, 462, etc., so that the present invention can utilize the limited number of pins in the integrated circuit to transmit signals.

To achieve the objective of the present invention, the ATA controller 430 has to control the timing carefully for sharing the pin. In other words, the ATA controller 430 of the I/O device 410 has to receive a signal, transmitted via the pins 470, from the ATA device 450 and detect the status of the shared pin 470a to take full control of the signals or data transmitted between different devices. Accordingly, the pin will be shared or switched under appropriate timing. To achieve the above-mentioned objective, when different peripheral device (e.g. 460 or 462) or different modules of peripheral devices submit requests for sharing a pin at the same time, the peripheral controller 420 will sort/prioritize the modules or the peripheral devices according to a sorting rule to generate a priority signal, so as to decide which one has the priority to use the shared pin. The sorting rule is determined by the processing priority and/or order of urgency among the modules and/or peripheral devices. According to the status of each pin 470, the ATA determination module 432 of the ATA controller 430 determines whether the I/O device 410 should switch the shared pin 470a to a pin-sharing mode to be accessed by the peripheral device (460, 462, etc.) For example, in the flash memory, to get the executable code has higher priority than on screen display (OSD).

Under the ATA protocol, the proper timing for the pin sharing according to the present invention is when some signal/data transfers take place, such as register transfer, PIO data transfer, multiword DMA data-in transfer, multiword DMA data-out transfer, ultra DMA data-in transfer, ultra DMA data-out transfer, and idle state (including that ultra DMA data-in transfer has stopped). The above data transfers may be also called host-controllable cycles of the ATA controller.

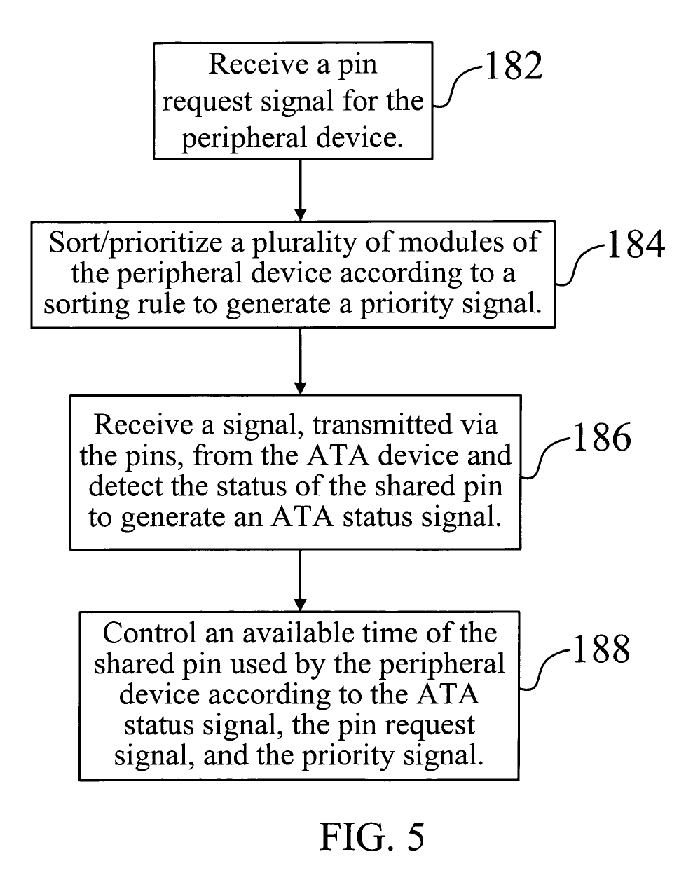

When the device is at the status of the host-controllable cycles of the ATA controller, it's a good timing for the present invention to share/switch the pin between the peripheral devices for transmitting data before or after one ATA data has been transmitted completely. Here, one ATA data can be a data of 8 bits when the transfer mode represents the register transfer or PIO data transfer. Or one ATA data can be a data of 16 bits for other transfer modes. The flowchart and the timing diagram of the present invention are described in the following together with FIGS. 5 through 12.

Referring to FIG. 5, FIG. 5 is a flowchart illustrating the pin sharing method according to an embodiment of the present invention. The pin sharing method of the present invention, together with the pin sharing system 100 shown in FIG. 1, includes the following steps:

Step 182: Receive a pin request signal for the peripheral device 160;

Step 184: Sort/prioritize a plurality of modules of the peripheral device 160 according to a sorting rule to generate a priority signal;

Step 186: Receive a signal, transmitted via the pins 170, from the ATA device 150 and detect the status of the shared pin 170a to generate an ATA status signal;

Step 188: Control an available time of the shared pin 170a used by the peripheral device 160 according to the ATA status signal, the pin request signal, and the priority signal.

Furthermore, according to another embodiment of the present invention together with the pin sharing system 400 shown in FIG. 4, the pin 470a is shared between a plurality of peripheral devices. In this embodiment, the pin sharing method further includes the following steps: Simultaneously receive a plurality of sub pin request signals for the peripheral devices (460, 462, etc.), synthesize the received sub pin request signals to generate the pin request signal, and sort/prioritize the peripheral devices (460, 462, etc.) according to the sorting rule to generate a priority signal.

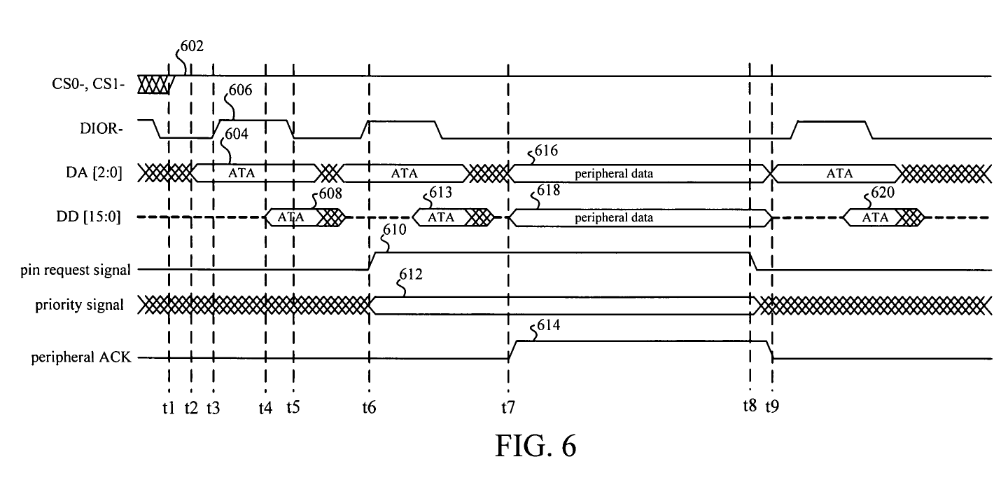

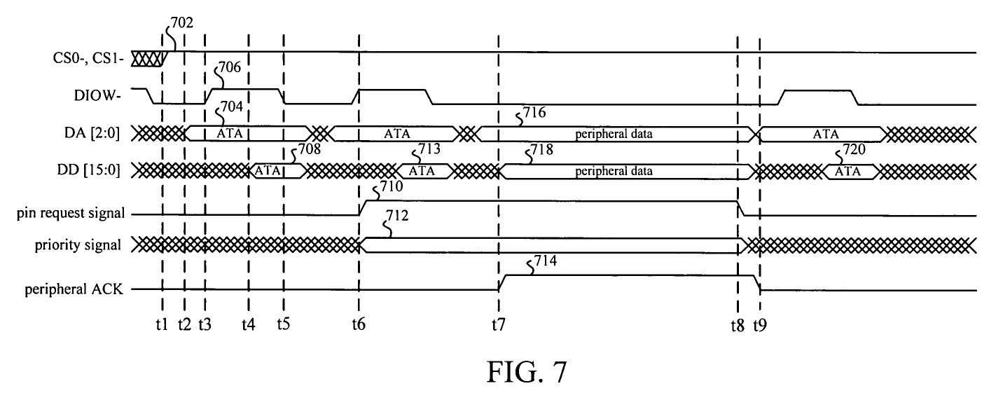

Referring to FIG. 6, FIG. 6 is a timing diagram illustrating the register/PIO data-in transfer according to the pin sharing method of the present invention. Before the signal 606 of the pin DIOR- is asserted at the time t3, the signal 602 of the pin CS0-/CS1- and the signal 604 of the pin DA[2:0] both have been asserted at the time t1 and t2 respectively. Before the signal 606 of the pin DIOR- is de-asserted at the time t5, the ATA device 450 has transmitted the signal 608 of the pin DD[15:0] at the time t4, so that an ATA data has been read. After the signal 606 of the pin DIOR- is de-asserted, the peripheral data can be transmitted. For example, when the peripheral controller 420 of the I/O device 410 receives the pin request signal for the peripheral devices (460 and/or 462, etc.) at the time t6 to share the pin with the ATA device 450, the peripheral controller 420 will transmit a request signal 610 and a priority signal 612 to the ATA controller 430. Afterward, after the ATA device transmits the current data 613, the ATA controller 430 will transmit a peripheral ACK 614 back to the peripheral controller 420 at the time t7, such that the shared pins DA[2:0] and DD[15:0] can transmit the signals 616 and 618 related to the peripheral data. After the peripheral data has been transmitted at the time t8, the peripheral ACK 614 is de-asserted at the time t9 to read the ATA data 620 under normal condition. Referring to FIG. 7, FIG. 7 is a timing diagram illustrating the register/PIO data-out transfer according to the pin sharing method of the present invention. Before the signal 706 of the pin DIOW- is asserted at the time t3, the signal 702 of the pin CS0-/CS1- and the signal 704 of the pin DA[2:0] both have been asserted at the time t1 and t2 respectively. Before the signal 706 of the pin DIOW- is de-asserted at the time t5, the ATA device 450 has transmitted the signal 708 of the pin DD[15:0] at the time t4, so that an ATA data has been written. After the signal 706 of the pin DIOW- is de-asserted, the peripheral data can be transmitted. For example, when the peripheral controller 420 of the I/O device 410 receives the pin request signal for the peripheral devices (460 and/or 462, etc.) at the time t6 to share the pin with the ATA device 450, the peripheral controller 420 will transmit a request signal 710 and a priority signal 712 to the ATA controller 430. Afterward, after the ATA device transmits the current data 713, the ATA controller 430 will transmit a peripheral ACK 714 back to the peripheral controller 420 at the time t7, such that the shared pins DA[2:0] and DD[15:0] can transmit the signals 716 and 718 related to the peripheral data. After the peripheral data has been transmitted at the time t8, the peripheral ACK 714 is de-asserted at the time t9 to write the ATA data 720 under normal condition.

According to the register/PIO data-out transfer, the output enable of the shared pin 470a is controlled by the ATA controller 430 during the whole process. So, after the pin DIOW- is asserted, it is also a proper timing for the shared pins DA[2:0] and DD[15:0] to transmit the related signals 716 and 718.

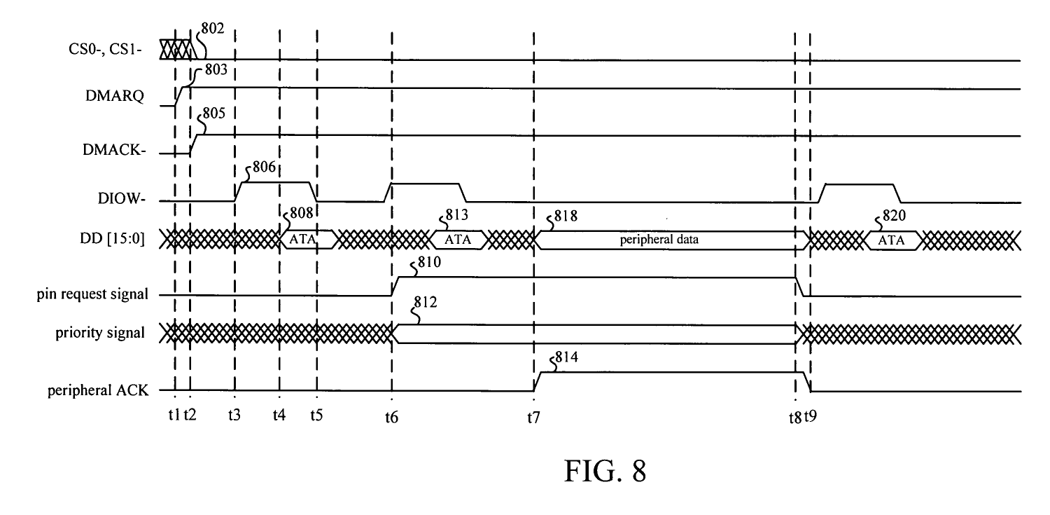

Referring to FIG. 8, FIG. 8 is a timing diagram illustrating the multiword DMA data-out transfer according to the pin sharing method of an embodiment of the present invention. After the ATA device 450 asserts the signal 803 of the pin DMARQ, the ATA controller 430 will de-assert the signal 802 of the pin CS0-/CS1- and assert the signal 805 of the pin DMACK- and the signal 806 of the pin DIOW-. Afterward, the ATA data is transmitted via the signal 808 of the pin DD[15:0] and then the signal 806 of the pin DIOW- is de-asserted, so that an ATA data has been written. After the signal 806 of the pin DIOW- is de-asserted, the peripheral data can be transmitted. For example, when the peripheral controller 420 of the I/O device 410 receives the pin request signal for the peripheral devices (460 and/or 462, etc.) at the time t6 to share the pin with the ATA device 450, the peripheral controller 420 will transmit a request signal 810 and a priority signal 812 to the ATA controller 430. Afterward, after the ATA device transmits the current data 813, the ATA controller 430 will transmit a peripheral ACK 814 back to the peripheral controller 420 at the time t7, such that the shared pin DD[15:0] can transmit the signal 818 related to the peripheral data. After the peripheral data has been transmitted at the time t8, the peripheral ACK 814 is de-asserted at the time t9 to write the ATA data 820 under normal condition.

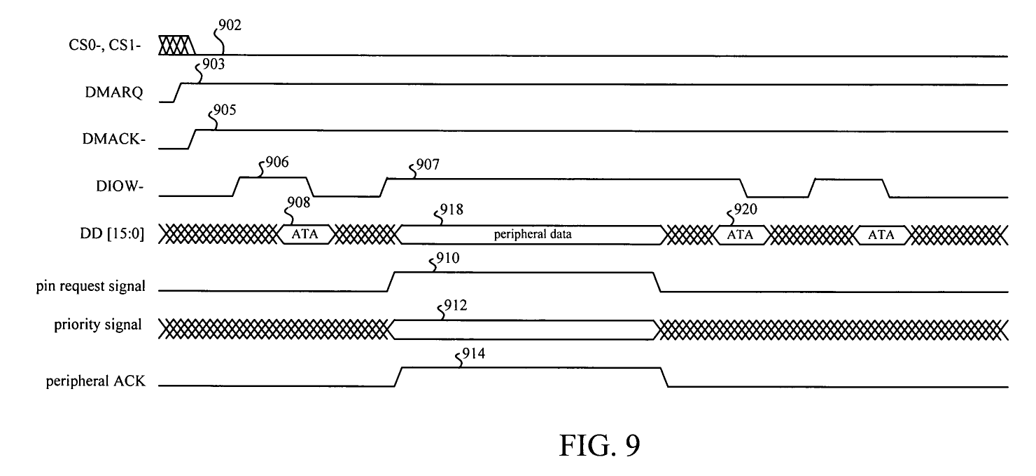

Referring to FIG. 9, FIG. 9 is another timing diagram illustrating the multiword DMA data-out transfer according to the pin sharing method of another embodiment of the present invention. After the ATA device 450 asserts the signal 903 of the pin DMARQ, the ATA controller 430 will de-assert the signal 902 of the pin CS0-/CS1-, assert the signal 905 of the pin DMACK-, the signal 906 of the pin DIOW-, and the signal 908 of the pin DD[15:0] and transmit the ATA data, so that recording of an ATA data would then be completed. Compared to FIG. 8, the difference is that though the signal 907 of the pin DIOW- is still asserted, the transmission of the peripheral data can be still on-going. At this time, if the peripheral controller 420 of the I/O device 410 receives the pin request signal for the peripheral devices (460 and/or 462, etc.) to share the pin with the ATA device 450, the peripheral controller 420 will also transmit a request signal 910 and a priority signal 912 to the ATA controller 430. Afterward, the ATA controller 430 will transmit a peripheral ACK 914 back to the peripheral controller 420, such that the shared pin DD[15:0] can transmit the signal 918 related to the peripheral data. After the peripheral data has been transmitted, the peripheral ACK 914 is de-asserted to write the ATA data 920 under normal condition.

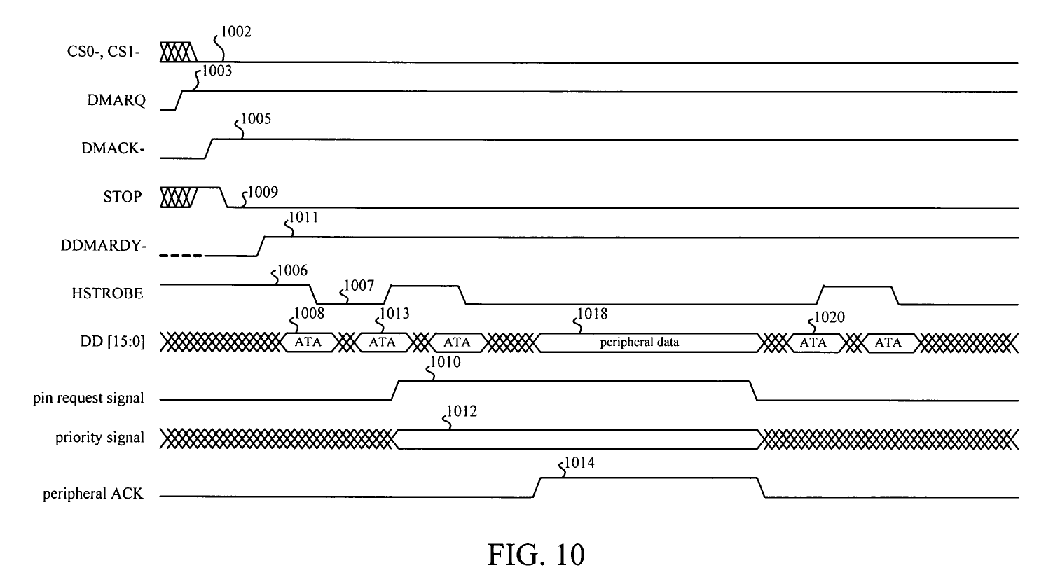

Referring to FIG. 10, FIG. 10 is a timing diagram illustrating the ultra DMA data-out transfer according to the pin sharing method of an embodiment of the present invention. After the ATA device 450 asserts the signal 1003 of the pin DMARQ, the ATA controller 430 will de-assert the signal 1002 of the pin CS0-/CS1- and assert the signal 1005 of the pin DMACK-, the signal 1009 of the pin STOP will be de-asserted, and the ATA device 450 will assert the signal 1011 of the pin DDMARDY, so as to notify the ATA controller 430 that the ATA device 450 is ready to transmit data. Afterward, the ATA controller 430 asserts the signal 1006 of the pin HSTROBE and enables the pin DD[15:0] to be ready to transmit data. The ATA controller 430 will assert and de-assert the signal of the pin HSTROBE and the signal of the pin DD[15:0] respectively for a span of time. After the signal of the pin HSTROBE is asserted or de-asserted, each ATA data (e.g. 1008, 1013, etc.) is capable of being transmitted. If the peripheral controller 420 of the I/O device 410 receives the pin request signal for the peripheral devices (460 and/or 462, etc.) to share the pin with the ATA device 450, the peripheral controller 420 will also transmit a request signal 1010 and a priority signal 1012 to the ATA controller 430. Afterward, the ATA controller 430 will transmit a peripheral ACK 1014 back to the peripheral controller 420, such that the shared pin DD[15:0] can transmit the signal 1018 related to the peripheral data. After the peripheral data has been transmitted, the peripheral ACK 1014 is de-asserted. When the signal of the pin HSTROBE is asserted or de-asserted again, the data of ATA device (e.g. 1020) is capable of being transmitted again.

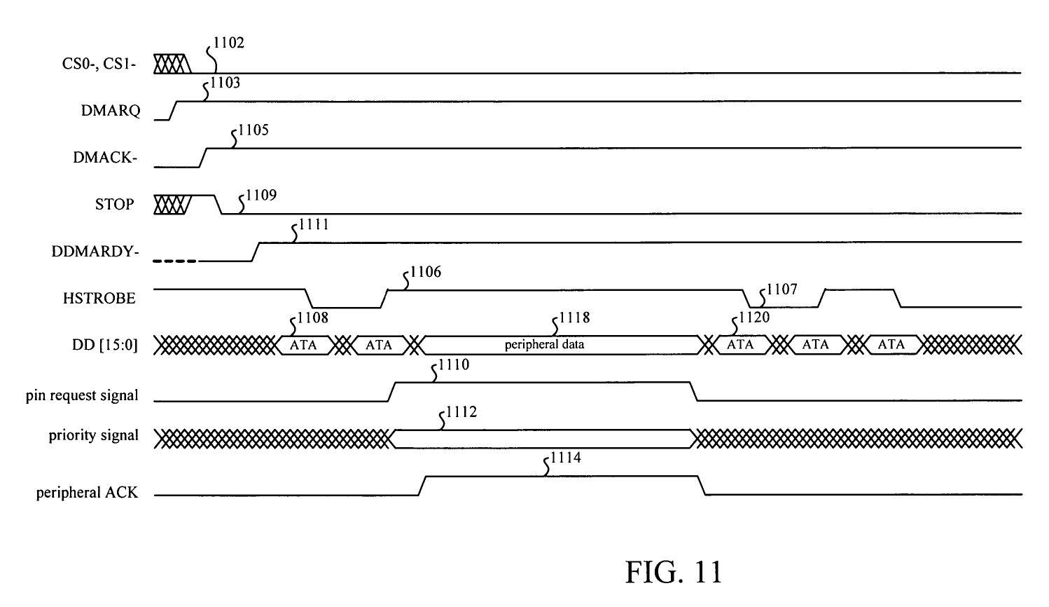

Referring to FIG. 11, FIG. 11 is another timing diagram illustrating the ultra DMA data-out transfer according to the pin sharing method of another embodiment of the present invention. The main difference between the embodiment of FIG. 11 and the embodiment of FIG. 10 is that though the signal 1106 of the pin HSTROBE is still asserted, the data 1118 of the peripheral device can be still transmitted.

Moreover, during the process of multiword DMA data-in transfer or ultra DMA data-in transfer, the ATA/ATAPI standard doesn't require that the ATA device 450 release the DD pin 470a after each ATA data has been transmitted. Therefore, if the peripheral device may release the DD pin 470a during the process of multiword DMA data-in transfer or ultra DMA data-in transfer, the pin 470a can be still shared with the peripheral devices.

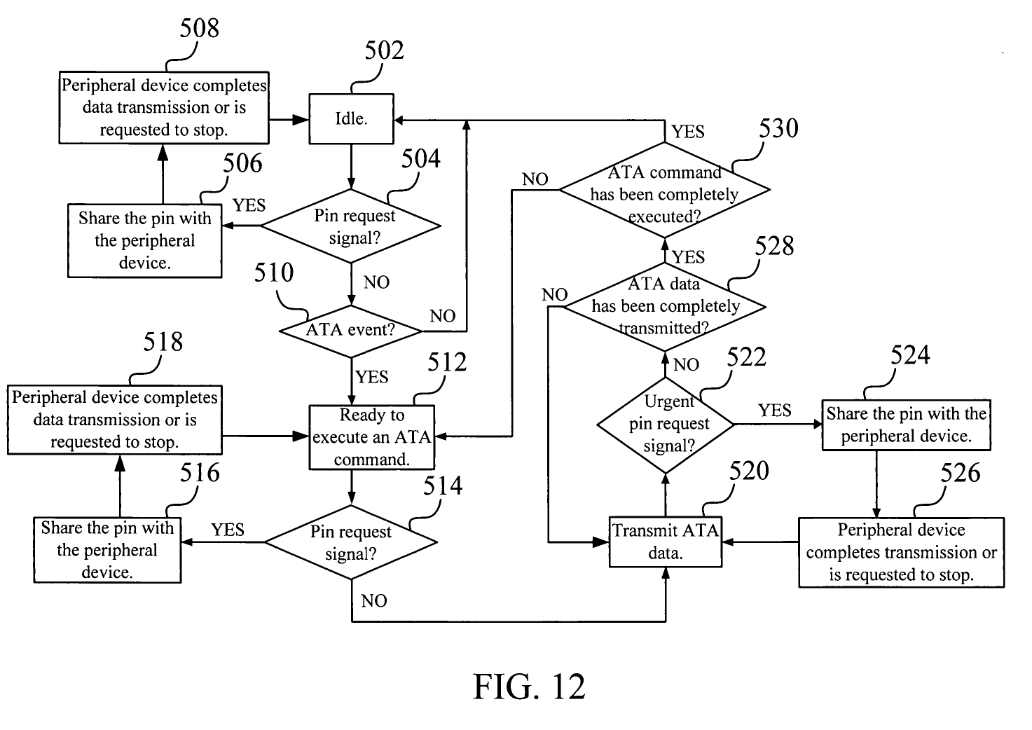

Referring to FIG. 12, FIG. 12 is a flowchart illustrating the pin sharing method according to another embodiment of the present invention. The pin sharing method of the present invention, together with the pin sharing system 400 shown in FIG. 4, includes the following steps:

Step 502: The ATA controller 430 is at an idle state;

Step 504: Whether the peripheral device 460/462 outputs a pin request signal? If it is a YES, go to step 506, otherwise go to step 510;

Step 506: Share the pin 470a with the peripheral device 460/462;

Step 508: The peripheral device 460/462 completes the data transmission or is requested to stop;

Step 510: Whether there is an ATA event? If it is a YES, go to step 512, otherwise go to step 502;

Step 512: Ready to execute an ATA command;

Step 514: Whether the peripheral device 460/462 outputs a pin request signal? If it is a YES, go to step 516, otherwise go to step 520;

Step 516: Share the pin 470a with the peripheral device 460/462;

Step 518: The peripheral device 460/462 completes data transmission or is requested to stop;

Step 520: The ATA data is transmitted between the I/O device 410 and the ATA device 450;

Step 522: Whether the peripheral device 460/462 outputs an urgent pin request signal? If it is a YES, go to step 524, otherwise go to step 528;

Step 524: Share the pin 470a with the peripheral device 460/462;

Step 526: The peripheral device 460/462 completes data transmission or is requested to stop;

Step 528: Whether the ATA data between the I/O device 410 and the ATA device 450 has been completely transmitted? If it is a YES, go to step 530, otherwise go to step 520;

Step 530: Whether the ATA command has been completely executed? If it is a YES, go to step 502, otherwise go to step 512.

According to the present invention, the pin sharing system and method thereof can share with at least one peripheral device one of a plurality of pins configured between an ATA device and an I/O device. The pin sharing system includes a peripheral controller, an ATA controller, and an I/O controller. The shared pin may be a DD pin or a DA pin.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A pin sharing system for sharing with a peripheral device one of a plurality of pins configured between an advanced technology attachment (ATA) device and an input/output (I/O) device, the system comprising:
a peripheral controller for receiving a pin request signal for the peripheral device and for generating a priority signal by sorting a plurality of modules of the peripheral device according to a sorting rule;
an ATA controller for receiving a signal, transmitted via the pins, from the ATA device and for detecting the status of the shared pin to generate an ATA status signal; and
an I/O controller, according to the ATA status signal, the pin request signal, and the priority signal, for controlling an available time of the shared pin used by the peripheral device.

2. The system of claim 1, wherein the shared pin is a device data pin (DD pin) used for transmitting data with the I/O device.

3. The system of claim 1, wherein the plurality of pins comprise a device address pin (DA pin) shared with the peripheral device and used for transmitting address with the I/O device.

4. The system of claim 1, wherein the shared pin is further shared with a plurality of peripheral devices.

5. The system of claim 4, wherein the peripheral controller simultaneously receives a plurality of sub pin request signals for the peripheral devices, synthesizes the received sub pin request signals to generate the pin request signal, and sorts the peripheral devices according to the sorting rule to generate a priority signal.

6. A pin sharing method for sharing with a peripheral device one of a plurality of pins configured between an advanced technology attachment (ATA) device and an input/output (I/O) device, the method comprising:
receiving a pin request signal for the peripheral device;
sorting a plurality of modules of the peripheral device according to a sorting rule to generate a priority signal;
receiving a signal, transmitted via the pins, from the ATA device and detecting the status of the shared pin to generate an ATA status signal; and
controlling an available time of the shared pin used by the peripheral device according to the ATA status signal, the pin request signal, and the priority signal.

7. The method of claim 6, wherein the shared pin is a device data pin (DD pin) used for transmitting data with the I/O device.

8. The method of claim 6, wherein the plurality of pins comprise a device address pin (DA pin) shared with the peripheral device and used for transmitting address with the I/O device.

9. The method of claim 6, wherein the shared pin is further shared with a plurality of peripheral devices.

10. The method of claim 9, further comprising:
simultaneously receiving a plurality of sub pin request signals for the peripheral devices and synthesizing the received sub pin request signals to generate the pin request signal; and
sorting the peripheral devices according to the sorting rule to generate a priority signal.
